(19) United States
(12) Patent Application Publication
(10) Pub. No.: US 2009/0126429 A1
(43) Pub. Date: May 21, 2009

(54) INPUT KEY AND METHOD OF MAKING THE SAME

(75) Inventors: WU-KUANG CHEN, Tu-Cheng (TW); HAO-ZHUAN LIN, Shenzhen (CN); XIAO-SHE BIAN, Shenzhen (CN); BAI-DA YU, Shenzhen (CN); QIANG ZHAO, Shenzhen (CN); GUANG-LIANG CHEN, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/965,762

(22) Filed: Dec. 28, 2007

(30) Foreign Application Priority Data
Nov. 15, 2007 (CN) 200710202544.6

(51) Int. Cl. E05B 19/26; B28B 11/08

(52) U.S. Cl. 70/395; 264/162

(57) ABSTRACT

An exemplary key includes a main body and a glazed layer. The main body has a contact receiving surface. The glazed layer is formed on at least one part of the contact receiving surface of the main body. The main body is made of ceramic materials. A method of making the present key is also provided.

### BACKGROUND OF THE INVENTION

1. Field of the Invention

The present invention relates to input keys, and particularly, to an input key used in an electronic device and a method of making the input key.

2. Discussion of the Related Art

Generally, a majority of foldable electronic devices, such as personal digital assistants (PDAs), mobile phones, MP3 players and MP4 players, have keyboards configured for users to input information. A keyboard includes a pad and a plurality of input keys positioned on the pad.

Typically, a method of making an input key (hereinafter key) includes the following steps: first, a melted plastic material is injection molded to form a plastic main body having a contact receiving surface, then an ink layer is formed on the contact receiving surface of the main body according to predetermined patterns to represent characters. When the keys are repeatedly struck, the ink layer may fade or become totally obliterated. In addition, problems such as distortion, scratching, and abrasion often occur due to a poor surface hardness of the main body. After the main body is distorted, abraded or scratched, the appearance of the key may not be as pleasant as the original appearance.

To overcome the problems such as distortion, scratching and abrasion of the main body, a main body made of metal is provided.

However, the problems such as distortion, scratching and abrasion of the main body still exist when the main body is made of metal. In addition, when the main body is made of metals, problems such as oxidation and/or fading of main body will be occurred. Furthermore, if the ink layer is formed on the metal main body by printing method, adhesion problems between the ink layer and the main body still occur.

What is needed, therefore, is a new key that can overcome the above-mentioned shortcomings such as scratching, abrasion, oxidation, and fading of the main body, and adhesion problems between the ink layer and the main body.

### SUMMARY

In one aspect, a key according to a preferred embodiment includes a main body and a glazed layer. The main body has a contact receiving surface. The glazed layer is formed on at least one part of the contact receiving surface. The main body is made of ceramic materials.

In another aspect, a method of making a key according to a preferred embodiment includes the following steps: forming a ceramic main body having a contact receiving surface; and forming a glazed layer on at least one part of the contact receiving surface of the main body.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present key. Moreover, in the drawings, like reference numerals designate corresponding parts throughout several views, and all the views are schematic.

FIG. 1 is an isometric view of the key according to a first preferred embodiment of the present invention.

FIG. 2 is a side, cross-sectional view of the key of FIG. 1, taken along line 11-11.

FIG. 3 is an enlarged view of a circled portion III of FIG. 2.

FIG. 4 is a flow chart of making the key of FIG. 1.

FIG. 5 is a side, cross-sectional view of the key according to a second preferred embodiment of the present invention.

### DETAILED DESCRIPTION OF THE PREFERRED EMBODIMENTS

Reference will now be made to the drawings to describe preferred embodiments of the key, and method of making the same, in details.

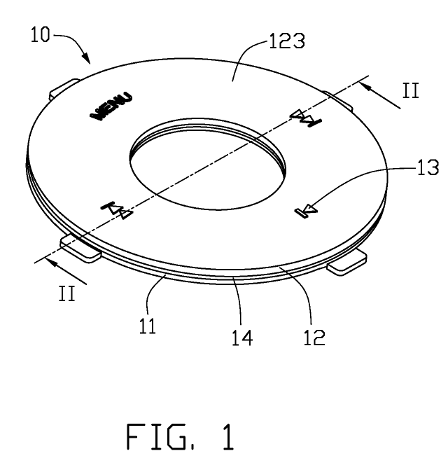

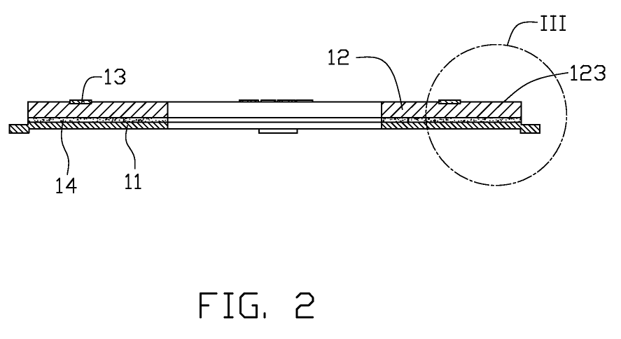

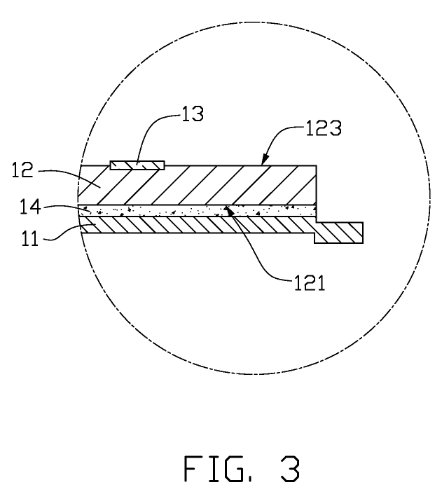

Referring to FIGS. 1 through 3, an input key 10 in accordance with a first preferred embodiment of the present invention is shown. The key 10 includes a base 11, a main body 12, and a glazed layer 13. A shape of the main body 12 is substantially a hollow cylinder. The main body 12 includes a bottom surface 121 and a contact receiving surface 123. The bottom surface 121 and the contact receiving surface 123 are on opposite surfaces of the main body 12. The contact receiving surface 123 is configured for being pressed. The base 11 is held to the bottom surface 121 of the main body 12 by an adhesive layer 14. The glazed layer 13 is formed on a predetermined area of the contact receiving surface 123. The main body 12 is made of ceramic materials, such as zirconia (ZrO₂) or alumina (Al₂O₃).

The glazed layer 13 is selected from the group consisting of a calcareous glaze, a feldspar glaze, a boracic glaze, and any suitable combination thereof. The glazed layer 13 on the main body surface 123 can be configured to be the following predetermined patterns: letters, numbers, symbols, and so on.

The base 11 is configured for connecting the main body 12 to a housing of an electronic device (not shown). Generally, the base 11 is made of plastics or rubber. Thus, the base 11 can absorb unexpected or deliberate shocks to protect the main body 12.

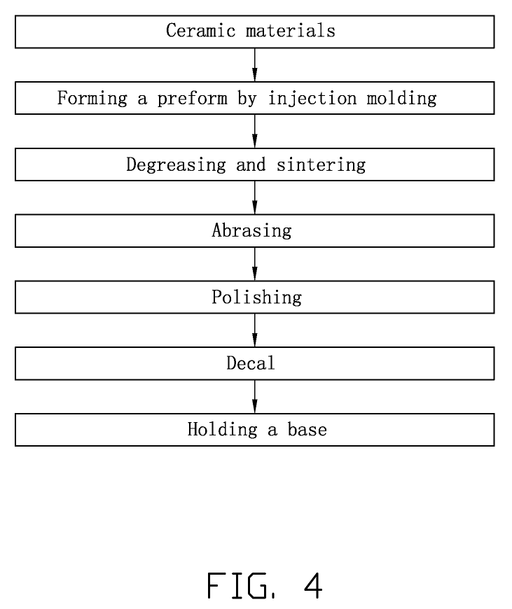

Referring to FIG. 4, a method of making the key 10 includes the following steps: firstly, a preform is formed by injection molding with ceramic materials. Then, the preform undergoes processes of degreasing and sintering, abrasing, and polishing in that order, to form the main body 12 having the contact receiving surface 123. Afterwards, the glazed layer 13 is coated on a part of the contact receiving surface 123 of the main body 12 by decal. Finally, the base 11 is held to the bottom surface 121 of the main body 12 by the adhesive layer 14. The adhesive layer 14 can be made of epoxy resins. Thus, the key 10 is achieved.

It is noted that, the contact receiving surface 123 of the main body 12 can be polished to form high-gloss surface or matte surface. In the illustrated embodiment, the contact receiving surface 123 of the main body 12 is, preferably, matte surface to achieve a good appearance and a good sense of touch.

The key 10 has a deformation protection such as high anti-distortion ability, high anti-scratch ability, and anti-abrasion ability due to the ceramic and glaze have high hardness. Also, the main body 12 is lacunaris because the main body 12 is made of ceramic. When forming the glazed layer 13 on the main body 12 by decal, the glazed layer 13 partially burns into the main body 12. Therefore, the glazed layer 13 is strongly embedded in the main body 12. As a result, the glazed layer 13 cannot be entirely rubbed off easily.

Furthermore, a desired color of the main body 12 can be achieved by varying ingredients of the ceramic material. The color of the main body can be red, yellow, green, blue, black, grey, and semi-transparent. In addition, the color of the main body 12 does not easily decolors, thus the key 1 0 has a high color preservative.

It can be understood that, the main body 12 also can be formed by dry pressing method or cold isostatic pressing method.

It can be understood that, the glazed layer 13 also can be formed entirely on the contact receiving surface 123, or partially on a side surface of the main body 12, or entirely on the side-surface. In addition, the glazed layer 13 also can be formed by spray glazing method, or printing glazing method.

It can be understood that, the base 11 and the adhesive layer 14 can be eliminated to simplify a configuration of the key 10.

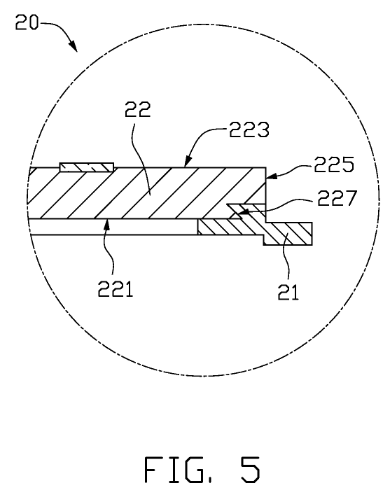

Referring to FIG. 5, a key 20 in accordance with a second preferred embodiment of the present invention is shown. The key 20 includes a base 21 and a main body 22 connecting with the base 21. The base 21 is integrally formed with the main body 22 by injection molding method. The main body 22 includes a bottom surface 221, a contact receiving surface 223 opposite to the bottom surface 221, a side-surface 225 adjoining the bottom surface 221 and the contact receiving surface 223. The side-surface 225 defines a latching groove 227 adjacent the edges of the bottom surface 221 of the main body 22. In this embodiment, a part of the base 21 is received in the latching groove 227 of the main body 22.

Because at least one portion of the base 21 is secured in the latching groove 227 of main body 22, the main body 22 and the base 21 can be fixed together without an adhesive layer. Moreover, because the base 21 is integrally formed with the main body 22 by injection molding, the base 21 with a complicated configuration can be made by injection molding easily.

It can be understood that, in the above mentioned key 10, 20, the contact receiving surface 123, 223 are both designed to be planar to achieve a good sense of touch. The contact receiving surface 223 of main body 22 can also be other shapes, such as a concave surface or a convexity surface. In addition, it can be understood that, to improve an appearance of the key 10, 20, a top plane view of the main body 22, 22 can be any other shapes, such as circular, ellipse, and polygon. The key can be used for other portable electronic devices such as keyboards of computers.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A key, used in an electron device, comprising a main body having a contact receiving surface, and a glazed layer formed on at least one part of the contact receiving surface of the main body, wherein the main body is made of ceramic materials.

2. The key according to claim 1, wherein the glazed layer is selected from the group consisting of a calcareous glaze, a feldspar glaze, a boracic glaze, and any suitable combination thereof.

3. The key according to claim 1, wherein the ceramic materials of the main body is one of zirconia and alumina.

4. The key according to claim 1, wherein a shape of the main body is a hollow cylinder.

5. The key according to claim 1, further comprising a base supporting the main body.

6. The key according to claim 5, further comprising an adhesive layer sandwiched between the base and the main body for connecting the base and the main body.

7. The key according to claim 5, wherein a side-surface of the main body defines a latching groove, at least one portion of the base is secured in the latching groove.

8. A method of making a key, comprising:
forming a ceramic main body having a contact receiving surface; and
forming a glazed layer on at least one part of the contact receiving surface of the main body.

9. The method of making a key according to claim 8, wherein the process of forming the main body comprises the following steps of:
forming a preform by injection molding;
degreasing and sintering the preform;
abrasing the contact receiving surface of the preform; and
polishing the contact receiving surface of the preform.

10. The method of making a key according to claim 8, wherein the glazed layer is formed on at least one of the contact receiving surface of the main body by decal.

11. The method of making a key according to claim 8, wherein the glazed layer is selected from the group consisting of calcareous glaze, feldspar glaze, boracic glaze, and any suitable combination thereof.

12. The method of making a key according to claim 8, wherein the ceramic materials of the main body is one of zirconia and alumina.

13. The method of making a key according to claim 8, wherein a shape of the main body is a hollow cylinder.

14. The method of making a key according to claim 8, wherein the main body further comprising a bottom surface opposite to the contact receiving surface and a side surface between the contact receiving surface and the bottom surface.

15. The method of making a key according to claim 14, wherein the bottom surface of the main body forms at least one latching groove therein, and a base is formed on the bottom surface of the main body by injection molding process, at least one portion of the base secured in the latching grooves of the main body.
